(19) United States
(12) Patent Application Publication
(10) Pub. No.: US 2024/0365782 A1
(43) Pub. Date: Nov. 7, 2024

(54) USE OF 2-AMINO-3-METHYLHEXANOIC ACID IN PROMOTING PLANT GROWTH AND INCREASING YIELD

(71) Applicants: NANJING AGRICULTURAL UNIVERSITY, Nanjing, Jiangsu (CN); NANJING TIANNONG BIOTECHNOLOGY CO., LTD., Nanjing, Jangsu (CN)

(72) Inventors: Shiguo CHEN, Nanjing (CN); He WANG, Nanjing (CN); Qian YANG, Nanjing (CN); Jingjing LI, Nanjing (CN); Wanping FANG, Nanjing (CN); Yu ZHANG, Nanjing (CN); Sheng QIANG, Nanjing (CN); Aiping GUO, Nanjing (CN)

(73) Assignees: NANJING AGRICULTURAL UNIVERSITY, Nanjing, Jiangsu (CN); NANJING TIANNONG BIOTECHNOLOGY CO., LTD., Nanjing, Jiangsu (CN)

(21) Appl. No.: 18/686,785

(22) PCT Filed: Aug. 23, 2022
(86) PCT No.: PCT/CN2022/114079

§ 371 Date: Feb. 26, 2024

(30) Foreign Application Priority Data
Aug. 24, 2021 (CN) 202110975196.6

(51) Int. Cl. A01N 37/44; A01P 21/00

(52) U.S. Cl. CPC A01N 37/44; A01P 21/00

(57) ABSTRACT

A use of 2-amino-3-methylhexanoic acid in promoting plant growth and increasing yield and use of the 2-amino-3-methylhexanoic acid in promoting growth of a plant seedling and/or promoting growth of a mature plant and increasing yield. The 2-amino-3-methylhexanoic acid is a natural product, has a simple structure, and is easy for industrial production. The 2-amino-3-methylhexanoic acid can promote plant growth and has the potential of being developed into a natural plant growth regulator. The 2-amino-3-methylhexanoic acid is a natural product, low in dosage, and environmentally friendly, has a remarkable promoting effect on plant growth, and thus is a green and efficient biological source plant growth regulator, which indicates the utilization value and application prospects of such substances in agricultural production.

### TECHNICAL FIELD

The present disclosure belongs to the field of agricultural biopesticides and relates to use of 2-amino-3-methylhexanoic acid in promoting plant growth and increasing yield.

### BACKGROUND

The growth and development of plants not only need the supply of light, water, nutrient substances and other resources, but also are regulated and controlled by growth substances. The plant growth substances mainly include two main classes of plant hormones and growth regulators. The plant growth regulators are artificially synthesized or extracted compounds having the physiological activity of natural plant hormones and can be used for regulating or controlling certain processes of plant growth and development, such as cell division and elongation, tissue and organ differentiation, seed dormancy and germination, flowering and fructification, maturation and aging and the like, thereby achieving the purposes of promoting or inhibiting seed germination, plant growth, fruit maturation, flower and fruit retention or thinning, improving plant immunity, helping plants resist adverse environments, relieving diseases, increasing crop yield, improving crop quality and the like. Due to their significant and efficient regulation effect, the plant growth regulators have been extensively used in various fields of grain, fruit trees, forests, vegetables and flowers, etc. At present, China has become one of the countries with the most extensive use of the plant growth regulators in the world.

The plant growth regulators play a great role in regulating and controlling the growth of crops, solve the problems that a plurality of traditional agricultural means cannot solve, and make important contributions to agricultural production and development in China. The use of the plant growth regulators has become one of the main measures for increasing the yield, improving the quality and increasing the efficiency of agriculture. However, the plant growth regulators belong to one of pesticides and also have certain toxicity. The food safety problem caused by blind and excessive use of the plant growth regulators still widely exists. The international standards on the residue limit of the plant growth regulators are also increasingly strict. Therefore, the development of a low-toxicity, highly efficient, and environmentally friendly plant growth regulator is of particular importance.

2-amino-3-methylhexanoic acid (MIA) with the empirical formula of C₇H₁₅NO₂ and the molecular weight of 145 g/mol belongs to a novel amino acid compound and is a colorless transparent crystal. There are 5 papers on the biological origin and activity of the compound. In 1981, Sugiura et al isolated 2-amino-3-methylhexanoic acid from an α-aminobutyrate-resistant mutant of Serratia marcescens, which was found to be synthesized via α-ketovaleric acid by enzymes from an isoleucine-valine biosynthetic pathway. In 1985, the team further speculated that the 2-amino-3-methylhexanoic acid might inhibit isoleucine biosynthesis. Biological activity studies showed that 2-amino-3-methylhexanoic acid had a remarkable inhibitory effect on Bacillus subtilis and Escherichia coli K-12, and bad a slight inhibitory effect on Achromobacter butyri, A. ureafaciens, E. coli B, and Pseudomonas aeruginosa, but had no inhibitory effect on Aerobacter aerogenes, Brevibacterium helvolum, P. fluorescens, and S. marcescens. In addition, Muramatsu et al discovered in 2002 that engineered Escherichia coli producing analogs hirudin could synthesize 2-amino-3-methylhexanoic acid, but the activity thereof was not studied. In 2018, a chemical synthesis method of 2-amino-3-methylhexanoic acid was established in the laboratory of the applicant, and US201810359759.7 was applied.

Recently, 2-amino-3-methylhexanoic acid has been successfully isolated and purified from Alternata sp., which is one of the main saprophytic phytopathogenic fungi widely existing in nature. This is also the first discovery that natural wild-type microorganisms are capable of producing 2-amino-3-methylhexanoic acid with the relatively high content. Its plant immunity and the induced resistance activity are systematically studied. It is found that in the aspect of resisting biotic stress, the 2-amino-3-methylhexanoic acid can effectively inhibit the generation and diffusion of viruses, fungi and bacteria on plant leaves; in the aspect of inducing the abiotic stress resistance of plants, the 2-amino-3-methylhexanoic acid can effectively relieve the damage of high temperature, low temperature, drought and salting to plants; and in the aspect of improving the quality, the 2-amino-3-methylhexanoic acid can improve the content of theanine and other amino acids in tea leaves. US202011549486.6 and 202110795699.5 have been filed. So far, there has been very little research on the 2-amino-3-methylhexanoic acid. Other than the 3 applied patents by us, the rest of studies have focused on biosynthetic pathways for the substance by bacterial mutants or recombinant engineered bacteria (non-natural microorganisms) and on direct inhibition of bacterial activity. There is no relevant research, report or patent concerning plant growth regulators, which is the novelty of the present patent.

### SUMMARY

The objective of the present disclosure is to provide use of 2-amino-3-methylhexanoic acid as a growth regulator in promoting plant growth and increasing yield aiming at the shortcomings of the prior art.

The objective of the present disclosure can be realized by the following technical solutions:

The 2-amino-3-methylhexanoic acid is used in promoting growth of a plant seedling and/or promoting growth of a mature plant and increasing yield.

The 2-amino-3-methylhexanoic acid is used in promoting growth of the plant seedling by soaking a seed.

The 2-amino-3-methylhexanoic acid is used in promoting root generation and growth of the plant seedling by a hydroponic treatment.

The 2-amino-3-methylhexanoic acid is used in promoting growth of the plant seedling by a stem and leaf treatment.

The 2-amino-3-methylhexanoic acid is used in promoting growth of the mature plant and increasing yield by a stem and leaf treatment.

The plant is selected from a grain crop, a vegetable, and a fruit. The grain crop is preferably rice, the vegetable is preferably a cucumber, a tomato and a hot pepper, and the fruit is preferably a strawberry.

The 2-amino-3-methylhexanoic acid is used in preparation of a plant growth regulator.

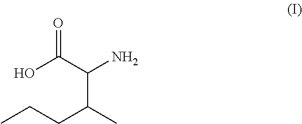

The existing related studies on the 2-amino-3-methylhexanoic acid have not been reported in the field of plant growth regulators. China is one of the most applied countries of plant growth regulators. With the increasing attention of the public on food safety and health, the development of a low-toxicity, highly efficient, and environmentally friendly plant growth regulator is of particular importance. Therefore, it is of great significance for guaranteeing food safety and improving the competitiveness of agricultural products to develop natural plant growth regulators and promote industrialization thereof. The 2-amino-3-methylhexanoic acid has a good performance in related experiments of promoting plant growth and can promote plant growth and improve yield.

The details and the embodiment of a method for using a natural product 2-amino-3-methylhexanoic acid separated from a plant pathogenic fungus Alternaria alternata for soaking a seed to promote growth of the plant seedling are as follows: the 2-amino-3-methylhexanoic acid can effectively promote growth of a rice seedling in a concentration range of 10-1,000 nM.

In a method for promoting rooting of a cucumber seedling by using the 2-amino-3-methylhexanoic acid, when the 2-amino-3-methylhexanoic acid in the concentration range of 10-1,000 nM is used to treat the cucumber seedling in a hydroponic method, it can significantly promote growth of the cucumber seedling and especially at a concentration of 100 nM, it increases the root length and lateral root number of the cucumber by 199% and 241%, respectively, compared to the blank control.

In a method for promoting growth of the plant seedling by using the 2-amino-3-methylhexanoic acid, when the 2-amino-3-methylhexanoic acid in the concentration range of 10-1,000 nM (0.02 vol % of a surfactant Tween 20 is added) is used to spray strawberry, tomato and hot pepper seedlings in a stem and leaf treatment method, it can significantly promote the development of the above plant seedlings. The growth vigor of plants is investigated after 9 days of application and it is found that the treatment by the 2-amino-3-methylhexanoic acid can significantly increase the plant height, the root length, and the root fresh weight.

In a method for promoting growth and fruit bearing of a strawberry by using 2-amino-3-methylhexanoic acid, when the 2-amino-3-methylhexanoic acid in the concentration range of 100-1,000 nM (0.02 vol % of the surfactant Tween 20 is added) is used to spray a strawberry plant in the stem and leaf treatment method, it can significantly promote the growth and fruit bearing of the strawberry. Especially at a treatment concentration of 1,000 nM, the plant height, the leaf number, and the leaf width of the strawberry are respectively improved by 49%, 79% and 32%, the chlorophyll content is improved by 21%, and the number and the mass of fruits per plant are improved by 39% and 44%, respectively.

### Technical Advancement and Beneficial Effects

The present disclosure has the following main advantages and positive effects:

The 2-amino-3-methylhexanoic acid is a natural product, has a simple structure, and is easy for industrial production. The present disclosure confirms that the 2-amino-3-methylhexanoic acid can promote plant growth and has the potential of being developed into a natural plant growth regulator.

The 2-amino-3-methylhexanoic acid is a natural product, low in dosage, and environmentally friendly, has a remarkable promoting effect on plant growth, and thus is a green and efficient biological source plant growth regulator, which indicates the utilization value and application prospects of such substances in agricultural production.

The present disclosure discovers that the 2-amino-3-methylhexanoic acid can promote growth and development of a plant by soaking a seed and a stem and leaf treatment. The 2-amino-3-methylhexanoic acid is convenient to use, solves the production problem that cannot be solved by the traditional agriculture, and reduces the production cost. In addition, since the 2-amino-3-methylhexanoic acid is a naturally existing metabolite with a simple structure and belongs to an α-amino acid, it has very high environmental and biological safety and belongs to the field of green and efficient biochemical pesticides.

### BRIEF DESCRIPTION OF THE DRAWINGS

FIG. 1 shows an effect of soaking seeds with different concentrations of 2-amino-3-methylhexanoic acid on growth of rice seedlings.

FIG. 2 shows an effect of a hydroponic treatment with different concentrations of 2-amino-3-methylhexanoic acid on rooting of cucumber seedlings.

FIG. 3 shows an effect of a stem and leaf treatment with 2-amino-3-methylhexanoic acid on growth of strawberry seedlings.

FIG. 4 shows an effect of a stem and leaf treatment with 2-amino-3-methylhexanoic acid on growth of tomato seedlings.

FIG. 5 shows an effect of a stem and leaf treatment with 2-amino-3-methylhexanoic acid on growth of hot pepper seedlings.

FIG. 6 shows a field application effect of a stem and leaf treatment with different concentrations of 2-amino-3-methylhexanoic acid on growth of strawberries.

### DETAILED DESCRIPTION

The inventor carries out studies on biological activity, application range and crop safety of 2-amino-3-methylhexanoic acid, and finds that the substance has a very unique effect on regulating and controlling crop growth, also has the advantages of environmental friendliness, wide applicability, safety in use and the like, is a natural plant growth regulator, and has the potential of being developed into a biopesticide. The essential features of the present disclosure can be reflected in the embodiments and examples described below, but should not be construed as limiting the present disclosure in any way.

### Example 1: Effect of Soaking Seeds with 2-Amino-3-Methylhexanoic Acid on Growth of Rice Seedlings

Rice seeds (variety “Dengliangyou 2108”) were washed clean with distilled water, disinfected with 75% alcohol for 3 minutes, washed with the distilled water for 3 times, and then disinfected with NaClO (5%) for about 10 minutes, taken out, and washed with the distilled water. Residual water on the surfaces of the seeds was absorbed with clean filter paper until the surfaces were dry and clean. 50 g of the healthy, full and uniform seeds were picked and placed in 100-mL conical flasks. 50 mL of a 2-amino-3-methylhexanoic acid aqueous solution with the concentrations of 0 nM, 10 nM, 100 nM and 1,000 nM was added into each bottle respectively, the seeds were soaked for 5 days at room temperature and taken out, 100 rice seeds to be tested with a consistent germination state were respectively selected, uniformly sowed in a rice seedling tray, and covered with sterile nutrient soil, the seedling tray was placed in a culture room at 28° C., and when 3 leaves and 1 heart of the rice seedlings were grown, the plant height, the root length, the root fresh weight and the overground part fresh weight of the rice seedlings were respectively measured.

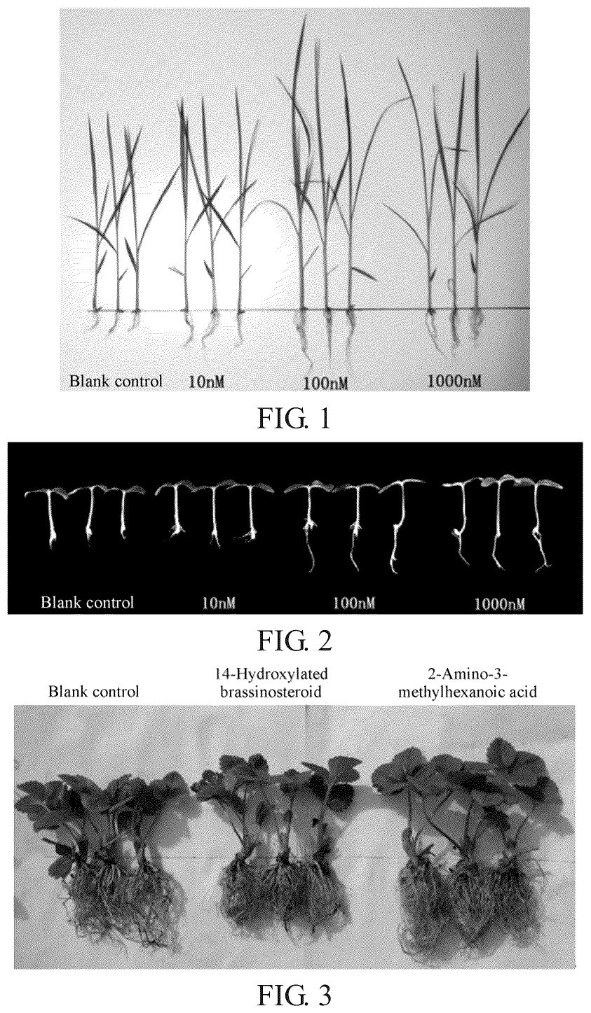

0.1 g of the rice leaves were accurately cut off for measuring the chlorophyll content. The rice leaves were extracted with 10 mL of an acetone ethanol extracting solution (80% acetone: 95% ethanol at a volume ratio of 1:1) for 24 hours in a dark place. A chlorophyll extracting stock solution was diluted by 3 times with the extracting solution as a reference solution, the light density values at wave lengths of 645 nm and 663 nm were measured with a spectrophotometer, and the chlorophyll content was calculated with a modifier formula of an Amnon method. The results were shown in Table 1 and FIG. 1.

$${Chl}_{a} = ( 12.71 {A}_{663} - 2.59 {A}_{645} ) \times n \times ( v / m )$$

$${Chl}_{b} = ( 22.88 {A}_{645} - 4.67 {A}_{663} ) \times n \times ( v / m )$$

$${Chl}_{t} = ( 8.04 {A}_{663} + 20.29 {A}_{645} ) \times n \times ( v / m )$$

In the formula, Ch1ₐ, Ch1_{b} and Ch1ₜ are the concentrations (mg/g·FW) of chlorophyll a, chlorophyll b and total chlorophyll, respectively; n is the dilution ratio; v is the volume of the extracting solution (L); m is the mass (g) of the leaves; and A₆₆₃ and A₆₄₅ are absorbance values of 663 nm and 645 nm, respectively.

TABLE 1
Effect of soaking seeds with different concentrations of
2-amino-3-methylhexanoic acid on growth of rice seedlings

| Treatment | | Plant height | Root length | Root fresh | Chlorophyll content |
|---|---|---|---|---|---|
| concentration | | (cm) | (cm) | weight (g) | (mg/g · FW) |
| Blank control | | 23.21 ± 0.11c | 7.30 ± 0.14c | 0.033 ± 0.002d | 2.75 ± 0.003c |
| (Clean water + | | | | | |
| 0.02% Tween 20) | | | | | |
| 10 | nM | 25.24 ± 0.82b | 8.34 ± 0.53b | 0.039 ± 0.002c | 3.60 ± 0.055b |
| 100 | nM | 29.88 ± 0.16a | 9.30 ± 0.26a | 0.069 ± 0.007a | 3.82 ± 0.079a |
| 1,000 | nM | 26.20 ± 0.32b | 8.30 ± 0.17b | 0.052 ± 0.003b | 3.63 ± 0.013b |

The results of Table 1 and FIG. 1 show that 2-amino-3-methylhexanoic acid with different concentrations of 10 nM-1,000 nM can effectively promote growth of rice seedlings, and the plant height, the root length, the root fresh weight, and the chlorophyll content of the rice seedlings were all significantly higher than those of a control group. When the concentrations were 10 nM, 100 nM, and 1,000 nM, respectively, the plant heights were improved by 9%, 29%, and 13%, respectively, the root lengths were improved by 14%, 27%, and 14%, respectively, the root fresh weights were improved by 18%, 109%, and 58%, respectively, and the chlorophyll contents were improved by 31%, 39%, and 32%, respectively, compared with the blank control. The effects were the best at a concentration of 100 nM.

### Example 2: Effect of 2-Amino-3-Methylhexanoic Acid on Rooting of Cucumber Seedlings

To further investigate a promoting effect of 2-amino-3-methylhexanoic acid on growth of plant roots, a model system for studying root generation, a radicle-removed cucumber seedling system, was selected. Four layers of wet gauze were spread on a bottom part of a seedling box, and healthy, full and uniform cucumber seeds (variety “Chuxiaqiuguan”, Ningyang County Luming Seed Co., Ltd., Shandong Province) were picked, washed with distilled water, uniformly spread on the gauze, and then covered with four layers of the wet gauze for keeping in a dark place. After kept in a dark place in a 25° C. culture room for 24 hours, the germinated cucumber seeds were taken out and buried in a position 1 cm below the soil, a plurality of plants with consistent growth vigor and completely unfolded two cotyledons were taken after 3 days, the roots were washed with the distilled water, the radicles were cut off, and the plants were fixed with sponge strips and placed in a centrifuge tube box. 400 mL of a 2-amino-3-methylhexanoic acid aqueous solution at concentrations of 0, 10, 100, and 1,000 nM, respectively was added to each box. The hydroponic plants were placed in the 25° C. culture room. After 6 days of light culture, the plants were taken out and the root length and number of newly generated roots were measured and recorded.

TABLE 2
Effect of different concentrations of 2-amino-3-methylhexanoic
acid on rooting of cucumber seedlings

| Treatment | | Root length (cm) | Lateral root number (piece) |
|---|---|---|---|
| Blank control | | 1.79 ± 0.99b | 5.67 ± 0.58b |
| (Clean water + | | | |
| 0.02% Tween 20) | | | |
| 10 | nM | 2.04 ± 0.67b | 16.00 ± 1.73a |
| 100 | nM | 5.36 ± 0.82a | 19.33 ± 1.53a |
| 1,000 | nM | 4.50 ± 1.28a | 14.33 ± 5.13a |

It can be seen from Table 2 and FIG. 2, 2-amino-3-methylhexanoic acid at different concentrations of 10 nM-1,000 nM can effectively promote growth of cucumber seedlings, where the effect of the treatment with 100 nM of the 2-amino-3-methylhexanoic acid was the most effective. At the concentrations of 10 nM, 100 nM, and 1,000 nM, the cucumber root lengths were improved by 33%, 199%, and 154%, respectively, and the number of root generation was improved by 182%, 241%, and 153%, respectively, compared with the blank control. The results show that the 2-amino-3-methylhexanoic acid can significantly promote the generation and growth of root systems of the cucumber seedlings.

### Example 3: Effect of Stem and Leaf Treatment with 2-Amino-3-Methylhexanoic Acid on Growth of Strawberry, Tomato and Hot Pepper Seedlings

In 2021, an experiment was conducted in a Changshanxiang Mingyang family farm (standard greenhouse nursery base) in Zhangjiagang city, Jiangsu province. A strawberry variety to be tested was Hongyan, a tomato variety was Qianxi, and a hot pepper variety was Sujiao No. 5. 2-amino-3-methylhexanoic acid was taken, dissolved with distilled water, and diluted with the distilled water to obtain a solution of 100 nM (14.5 μg/L), a blank control was additionally set, and 0.02% Tween 20 as a surfactant and 14-hydroxylated brassinosteroid (Sichuan New Sun company) with the concentration of 37.5 μg/L as a control agent were added at the same time. Each treatment was repeated three times, the plot area was 20 m², and the liquid injection volume per plot was 1 L. The treatment method was foliage spray, an investigation was conducted on day 9 after the application, and the results were shown in Tables 3-5 and FIG. 3-FIG. 5.

TABLE 3
Effect of stem and leaf treatment with 2-amino-3-methylhexanoic
acid on growth of strawberry seedlings

| | Plant height | Root length | Root fresh weight |
|---|---|---|---|
| Treatment | (cm) | (cm) | (g) |
| Blank control | 5.33 ± 0.12b | 4.72 ± 0.31b | 4.99 ± 0.081b |
| (Clean water + | | | |
| 0.02% Tween 20) | | | |
| 14-hydroxylated | 6.54 ± 0.060a | 4.67 ± 0.20b | 5.14 ± 0.10b |
| brassinosteroid | | | |
| (37.5 μg/L) | | | |
| 2-amino-3-methyl- | 7.00 ± 0.37a | 5.79 ± 0.36a | 8.49 ± 0.12a |
| hexanoic acid | | | |
| (14.5 g/L, 100 nM) | | | |

The results in Table 3 and FIG. 3 show that the stem and leaf spray treatment with the 2-amino-3-methylhexanoic acid could significantly improve the plant height, the root length, and the root fresh weight of strawberry seedlings compared with the blank control. When the amount of the 2-amino-3-methylhexanoic acid was 14.5 μg/L, the plant height, the root length, and the root fresh weight were improved by 31%, 23%, and 70%, respectively, compared with the blank control (clean water+0.02% Tween 20), and the plant height, the root length, and the root fresh weight were improved by 7%, 24%, and 65%, respectively, compared with 14-hydroxylated brassinosteroid with the amount of 37.5 μg/L.

TABLE 4
Effect of stem and leaf treatment with 2-amino-3-
methylhexanoic acid on growth of tomato seedlings

| | Plant height | Root length | Root fresh weight |
|---|---|---|---|
| Treatment | (cm) | (cm) | (g) |
| Blank control | 11.32 ± 0.11b | 3.91 ± 0.98a | 1.22 ± 0.10c |
| (Clean water + | | | |
| 0.02% Tween 20) | | | |
| 14-hydroxylated | 11.81 ± 0.36b | 4.56 ± 0.62a | 3.49 ± 0.14b |
| brassinosteroid | | | |
| (37.5 μg/L) | | | |
| 2-amino-3-methyl- | 20.80 ± 0.21a | 5.39 ± 0.43a | 4.05 ± 0.07a |
| hexanoic acid | | | |
| (14.5 μg/L, 100 nM) | | | |

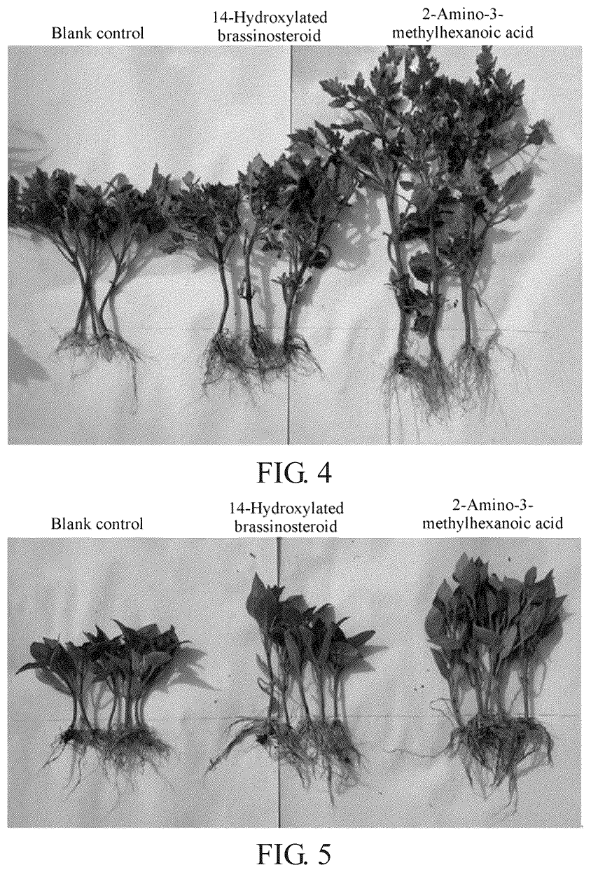

The results in Table 4 and FIG. 4 show that the stem and leaf spray treatment with the 2-amino-3-methylhexanoic acid can significantly improve the plant height, the root length, and the root fresh weight of tomato seedlings compared with the blank control. When the amount of the 2-amino-3-methylhexanoic acid was 14.5 μg/L, the plant height, the root length, and the root fresh weight were improved by 84%, 38%, and 232%, respectively, compared with the blank control (clean water+0.02% Tween 20), and the plant height, the root length, and the root fresh weight were improved by 76%, 18%, and 16%, respectively, compared with 14-hydroxylated brassinosteroid with the amount of 37.5 μg/L.

TABLE 5
Effect of stem and leaf treatment with 2-amino-3-methylhexanoic
acid on growth of hot pepper seedlings

| | Plant height | Root length | Root fresh weight |
|---|---|---|---|
| Treatment | (cm) | (cm) | (g) |
| Blank control | 5.81 ± 0.16c | 3.11 ± 0.30b | 3.14 ± 0.10c |
| (Clean water + | | | |
| 0.02% Tween 20) | | | |
| 14-hydroxylated ± | 6.78 ± 0.29b | 4.22 ± 0.39ab | 3.45 ± 0.16b |
| brassinosteroid | | | |
| (37.5 μg/L) | | | |
| 2-amino-3-methyl- | 9.32 ± 0.32a | 4.53 ± 0.33a | 4.67 ± 0.09a |
| hexanoic acid | | | |
| (14.5 μg/L, 100 nM) | | | |

The results in Table 5 and FIG. 5 show that the stem and leaf spray treatment with 2-amino-3-methylhexanoic acid can significantly improve the plant height, the root length, and the root fresh weight of hot pepper seedlings compared with the blank control. When the amount of the 2-amino-3-methylhexanoic acid was 14.5 μg/L, the plant height, the root length, and the root fresh weight were improved by 60%, 46%, and 49%, respectively, compared with the blank control (clean water+0.02% Tween 20), and the plant height, the root length, and the root fresh weight were improved by 37%, 7%, and 35%, respectively, compared with 14-hydroxylated brassinosteroid with the amount of 37.5 μg/L. By combining the above results, the 2-amino-3-methylhexanoic acid can effectively promote growth of a plant seedling.

### Example 4: Effect of Stem and Leaf Treatment with 2-Amino-3-Methylhexanoic Acid on Growth of Mature Strawberry Plants

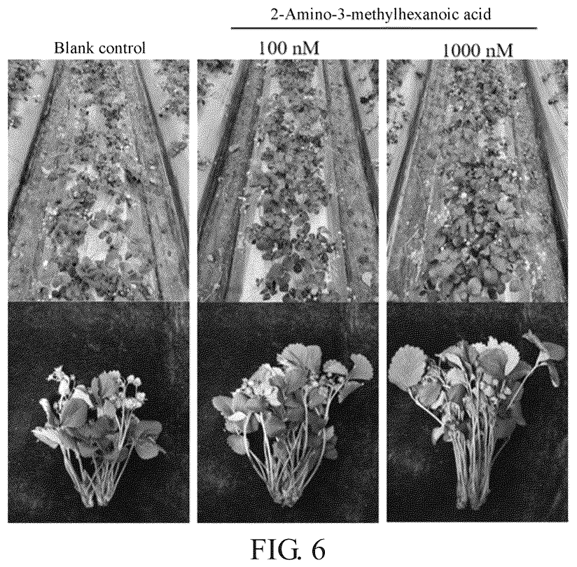

On Feb. 27, 2021, an experiment was conducted in a greenhouse of a farm of Baitu town, Jurong city, Jiangsu province, and the strawberry variety to be tested was Hongyan. The 2-amino-3-methylhexanoic acid was taken, dissolved with distilled water, and gradiently diluted with the distilled water to obtain solutions of 1,000 nM and 100 nM, a blank control was additionally set, and 0.02% Tween 20 as a surfactant was added at the same time. Each treatment was repeated three times, the plot area was 100 m², and the liquid injection volume per plot was 4.5 L. Three times of field application were conducted on February 27, March 3, and Mar. 8, 2021, respectively. The treatment method was foliage spray. The plant height, the leaf number, the leaf width, the number of fruits per plant, and the mass of fruits per plant were investigated on March 8. 0.2 g of strawberry leaves were cut off at the same time for measuring the chlorophyll content. The specific measuring method was shown in example 1 and the results were shown in Tables 6-7 and FIG. 6.

TABLE 6
Effect of stem and leaf treatment with different concentrations
of 2-amino-3-methylhexanoic acid on growth of strawberries

| | | Plant height | Leaf number | Leaf width | Chlorophyll content |
|---|---|---|---|---|---|
| Treatment | | (cm) | (leaf) | (cm) | (mg/g · FW) |
| Blank control | | 24.54 ± 2.78b | 14.56 ± 3.776 | 4.99 ± 0.96b | 3.08 ± 0.41b |
| (Clean water + | | | | | |
| 0.02% | | | | | |
| Tween 20) | | | | | |
| 100 | nM | 26.50 ± 3.60b | 22.44 ± 4.32b | 5.33 ± 0.48b | 3.50 ± 0.30ab |
| 1,000 | nM | 36.60 ± 3.28a | 26.00 ± 4.76a | 6.59 ± 1.07a | 3.74 ± 0.65a |

It can be seen from Table 6 and FIG. 6 that with the increase of the concentration of the stem and leaf spray treatment with the 2-amino-3-methylhexanoic acid, a promotion effect on growth of strawberry plants was improved. Compared with the blank control, the plant height, the leaf number, the leaf width, and the chlorophyll content of the strawberry plants treated with 1,000 nM of the 2-amino-3-methylhexanoic acid were improved by 49%, 79%, 32%, and 21%, respectively.

TABLE 7
Effect of stem and leaf treatment with different concentrations
of 2-amino-3-methylhexanoic acid on yield traits of strawberries

| | Number of fruits per | Mass of fruits |
|---|---|---|
| Treatment | plant (fruit) | per plant (g) |
| Blank control | 7.00 ± 1.19c | 23.99 ± 0.42c |
| (Clean water + | | |
| 0.02% Tween 20) | | |

| | | | |
|---|---|---|---|
| 100 | nM | 8.32 ± 0.47b | 29.06 ± 0.76b |
| 1,000 | nM | 9.72 ± 0.43a | 34.47 ± 0.58a |

It can be seen from Table 7 that with the increase of the concentration of the stem and leaf spray treatment with 2-amino-3-methylhexanoic acid, the number and the mass of fruits per strawberry plant were improved. The number and the mass of fruits per strawberry plant after the treatment with 1,000 nM of the 2-amino-3-methylhexanoic acid were improved by 39% and 44%, respectively, compared to the blank control. The results show that the 2-amino-3-methylhexanoic acid can significantly promote growth of the strawberry plants, improve the chlorophyll content, and increase the percentage of fertile fruit and yield of the strawberries.

### REFERENCES

[1] Sugiura M, Kisumi M, Chibata I. β-methylnorleucine, an antimetabolite produced by Serratia marcescens [J]. Journal of Antibiotics 1981, 34 (10): 1278-82.
[2] Sugiura M, Kisumi M, Chibata I. Biosynthetic pathway of beta-methylnorleucine, an antimetabolite produced by Serratia marcescens [J]. Journal of Antibiotics, 1981, 34 (10): 1283-9.
[3] Sugiura M, Kisumi M, Chibata I. β-methylnorleucine, a novel antagonist of isoleucine. Agricultural and Biological Chemistry 1985, 49 (6): 1889-1890.
[4] Muramatsu R, Negishi T, Mimoto T, Miura A, Misawa S, Hayashi H. Existence of β-methylnorleucine in recombinant hirudin produced by Escherichia coli [J]. Journal of Biotechnology 2002, 93 (2): 131-142.
[5] Muramatsu R, Misawa S, Hayashi H. Finding of an isoleucine derivative of a recombinant protein for pharmaceutical use. Journal of Pharmaceutical and Biomedical Analysis 2003, 31:979-987.
[6] Qiang Sheng, Zhang Qian, Wang Zhongchang, Zhu Hailiang, and Chen Shiguo. A synthesis method for alkyl glycine. Chinese patent of invention and application No. 201810359759.7
[7] Chen Shiguo, Li Jingjing, Wang Lan, Wang He, Qiang Sheng, Fang Wanping, and Zhang Yu. Use of 2-amino-3-methylhexanoic acid as a plant immunity inducer. Chinese patent of invention and patent number ZL202011549486.6.
[8] Chen Shiguo, Li Jingjing, Wang Lan, Wang He, Qiang Sheng, Fang Wanping, and Zhang Yu. Use of 2-amino-3-methylhexanoic acid in improving quality of tea leaves. Chinese patent of invention and application No. 202110795699.5.
[9] Xu BM. The Seedling Evaluation and Vigour Test [M]. Beijing: China Agricultural University Press, 2002:53-68.

1. A method for promoting growth of a plant seedling and/or promoting growth of a mature plant and increasing yield, the method comprising treating the plant seedling and/or the mature plant with 2-amino-3-methylhexanoic acid to promote growth of the plant seedling and/or promote growth of the mature plant and increase yield.

2. The method according to claim 1, wherein the 2-amino-3-methylhexanoic acid is used in promoting root generation and growth of the plant seedling by a hydroponic treatment.

3. The method according to claim 1, wherein the 2-amino-3-methylhexanoic acid is used in promoting growth of the plant seedling by a stem and leaf treatment.

4. The method according to claim 1, wherein the 2-amino-3-methylhexanoic acid is used in promoting growth of the mature plant and increasing yield by a stem and leaf treatment.

5. The method according to claim 1, wherein the plant is selected from a grain crop, a vegetable, and a fruit.

6. The method according to claim 5, wherein the grain crop is rice.

7. The method according to claim 5, wherein the vegetable is a cucumber, a tomato, or a hot pepper.

8. The method according to claim 5, wherein the fruit is a strawberry.

9. A plant growth regulator for promoting growth of a plant seedling and/or promoting growth of a mature plant and increasing yield, the plant growth regulator comprising 2-amino-3-methylhexanoic acid.
